(19) United States
(12) Patent Application Publication
(10) Pub. No.: US 2021/0094755 A1
(43) Pub. Date: Apr. 1, 2021

(54) DIFFUSER GUIDE CONSTRUCTION FOR BULK MATERIAL CONTAINERS

(71) Applicant: Martin Huebner, Trierweiler (DE)

(72) Inventor: Martin Huebner, Trierweiler (DE)

(21) Appl. No.: 17/013,701

(22) Filed: Sep. 7, 2020

(30) Foreign Application Priority Data
Sep. 6, 2019 (EP) 19195915.4

(51) Int. Cl. B65D 88/72; B65D 88/74

(52) U.S. Cl. CPC B65D 88/72; B65D 88/745

(57) ABSTRACT

The invention relates to a diffuser guide construction for evening the flow of bulk material in a bulk material container, wherein the diffuser guide construction is formed by at least one central tube which is either open at the top and tapers upwards or is closed at the top. The invention also relates to a bulk material container comprising such a diffuser guide construction and the use of a diffuser guide construction for evening a flow of bulk material.

### CROSS REFERENCE TO RELATED APPLICATION

This application claims priority to European patent application EP19195915.4 dated Sep. 6, 2019, which is incorporated herein by reference in its entirety.

### BACKGROUND AND INTRODUCTION TO THE INVENTION

In the production and processing of bulk material, the bulk material is usually temporarily stored in bulk material containers or has to flow through bulk material containers for certain processing steps. Such bulk material containers for plastic granulate are described, inter alia, in DE 9409062U1 or DE 3131471 C3.

In a classic dryer, air circulates between a drying container and a dehumidifier. In the dehumidifier, dry air is generated, which is blown into the central injection device with a powerful supply air fan. The dry air escapes through the lower cone made of perforated sheet metal into the granulate drying area, and substantially rises upwards. The granulate to be dried fed in from above is flowed through in the direction opposite to its flow direction (from top to bottom). The warm, dry air removes the moisture from the granulate and absorbs it. The air humidified in this way is sucked in by the exhaust fan and conveys it on to the air dehumidifier, where it is dehumidified again.

This cycle is a continuous process. The dehumidifier has two dehumidifying lines, wherein only one line dehumidifies. While one line dehumidifies the air, the other line is “freed” from the previously absorbed moisture; one speaks here of regeneration.

When processing hygroscopic plastic granules, dry, warm air flows through them in containers as described above. It is important here that the dwell time/throughput time of all bulk plastics should be as uniform as possible over the entire cross-section, so that the moisture present in a more or less pronounced manner in the interior of the granulate grains diffuses to the outside and can be absorbed by the dry and warm air.

If a granulate is not sufficiently dried, the existing moisture leads to massive problems during further processing. Even small amounts of moisture, especially in PET granules, trigger a chain of reactions. At temperatures above the melting point (e.g. 250° C. for PET), rapid hydrolysis sets in, i.e. the water separates the chemical components, thereby reducing the molecular weight, along with lowering of the intrinsic viscosity and the associated physical properties, resulting in a loss in strength.

A granulate with as evenly low moisture as possible leads to a uniform viscosity of the goods to be dried being guaranteed during further processing, i.e. the material properties are not negatively influenced by moisture.

The energy required for drying can only be brought in via the amount of air. However, the air speed may only be selected so high that the bed does not yet “loosen up” (loosening point: the start of granules floating). If the air speed is increased above the loosening point, flight promotion begins.

DE 19536549 A1 belongs to the prior art and discloses a device for loading and emptying a bulk material container. The bulk material is guided above the lower outlet via at least two conical funnel-shaped channels running towards the center of the outlet. These funnel elements should mean that all areas of the bulk material container are flowed through almost equally by the bulk material. In practice, this device has brought about a certain improvement, but it has not yet been possible to achieve a uniform flow of bulk material.

Most dryer manufacturers derive the calculation of the flow rate from the following physical quantities:

a) Capacity (volume) of the dryer,

b) Specified dwell time of the material to be dried (material characteristic of e.g. polyester, PA6/PA6.6 etc.), with a corresponding degree of drying of the air, as well as the moisture content of the goods to be dried)

c) Granulate grain size

In the following, the region between the upper level of the bulk material and the start of the funnel area is referred to as sub-region A. The mostly funnel-shaped outlet area is referred to as sub-region B. This is mostly done on the assumption that the granulate moves fairly evenly through the container (above all sub-region A) and thus also evenly into the funnel of sub-region B, and thus reaches the exit point. It is not the case that the flow of the bulk material is uniform, especially in the case of containers with a central injection device, because here there are two regions in which the material flow or the material movement are extremely different. So there is no flow at all in the space above the air distribution cone. The grains of material remain on the flank of the air distribution cone/storage surface (indicated by stripes in FIG. 1). Here the effective material flow is practically zero.

On the other hand, a region of preferred flow (core flow) occurs at the outer edge of the dryer, which is indicated as stripes in FIG. 1. In this region, the effective material flow is significantly higher than the calculated material flow.

The effective maximum quantity withdrawn of sufficiently dried material is, among other things, a function of the core flow rate. The quantity withdrawn from the dryer must be throttled so that the flow rate in the core flow zone is so slow that each individual grain of material has a sufficient dwell time in the dry air flowing through the dryer. Of course, the grain size also plays a role here, since the rate of diffusion of moisture in the grain depends on the material to be dried itself (material property). Furthermore, the maximum quantity withdrawn is influenced by the temperature and degree of drying (partial pressure difference, i.e. moisture concentration difference) of the drying air.

The dryers described above (with a central injection device) therefore usually have three significant weak points due to the vastly different flow rates.

1) Design/Dimensioning Problem

The dimensioning of the dryer designed by the manufacturers with regard to maximum dryer output (dries xy−kilograms per hour) is not achieved due to the core flow problem/preferred flow, because the dwell times of the granules in the core flow area are not sufficient to become dry. The system must be operated (in some cases significantly) below the theoretically calculated maximum design quantity. Alternatively, due to the experience mentioned above, the systems must be dimensioned significantly larger in order to obtain sufficiently well-dried material.

2) Processing/Quality Problems in Further Processing (e.g. Injection-Molding Machines or Fiber Production)

Insufficiently dried granulate leads to processing problems due to the hydrolysis that occurs and the associated loss of strength. This can be compensated for by reducing the quantity withdrawn, whereby the essential question arises as to whether the quantity required for the production process can still be achieved.

The overdrying of the material also leads to serious quality problems during further processing, however, because even material that has been dried for too long (overdried) leads to processing problems. If the granulate, which has long accumulated above the air distribution cone, ends up in the further process, this leads to massive quality problems. Depending on the material, the long dwell time (remaining on the injection funnel) results in thermal damage, loss of auxiliary materials (flame hammers, lubricants, plasticizers, etc.) or condensation of the material and thus a massive increase in viscosity, which has a massive impact on further processing.

This not only leads to problems when melting in the extruder (process pressure or fluctuations in speed in the plasticizing), but especially when injecting the material into the forming tool, because at the boundary layers, where material with normal viscosity (from the core flow area) reaches material with significantly higher viscosity, the material tears open because the materials of the different viscosities do not bond with one another sufficiently.

This slipping of the standing material always happens when the dryer is run empty, so that in this case the entire contents of the dryer lead to rejects in the subsequent process.

However, not only when running empty, but also when the overall flow is interrupted (for example, a short stop or a change in the amount withdrawn from the dryer), the condensed granule grains are entrained, which also causes the aforementioned problems.

3) Energetic Problem

The quantity of air that flows through the standing material is ineffective for drying. As a result, it only increases the exhaust air temperature and thus worsens the thermal efficiency.

It was therefore the object of the invention to provide a bulk material container which does not have the disadvantages of the prior art and, above all, enables a more even flow of the bulk material.

### BRIEF DESCRIPTION OF THE FIGURES

FIG. 1 shows a prior art embodiment.

FIG. 2A shows an open diffuser guide construction with three guide plates 8.

FIG. 2B shows the embodiment of FIG. 2A, but also shows an air distribution cone 3.

FIG. 2C shows a bulk material container 9 with an open diffuser guide construction with three guide plates 8.

FIG. 3 shows a preferred embodiment of the invention with a plurality of guide plates 8 of an open diffuser guide construction.

FIG. 4 shows an embodiment with a tube 11 closed at the top, which does not taper upwards.

FIG. 5 shows a variant in which the guide plate of the diffuser guide construction is formed by the air supply pipe 10 of the central injection device.

### SUMMARY AND DESCRIPTION OF THE INVENTION

The object is achieved by the embodiments of the independent claims. Preferred embodiments can be found in the dependent claims.

In a first preferred embodiment, the invention relates to a bulk material container comprising a centrally running injection device with an air distribution cone and a diffuser guide construction for pourable bulk material, the diffuser guide construction being arranged essentially centrally in the bulk material container and comprising at least one guide plate,

wherein the guide plate is arranged at least partially around the air distribution cone and is in the form of a tube which tapers upwards or is closed at the upper end. If the tube is closed, it is preferred that the tube is closed in a tapered manner, for example in the form of a cone.

When the tube tapers upwards, the guide plate essentially has the basic shape of a jacket of a truncated cone, wherein the opening on the lower side is larger than the opening on the upper side. This means that this diffuser guide construction is constructed in such a way that it approximates the geometry of an inverted funnel. This is a departure from the prior art, since funnel-shaped guide plate structures have been used to improve the evenness of the material flow. A great advantage of this embodiment is that hardly any volume in the bulk material container is lost due to the construction. This type of diffuser guide construction is also referred to as an open diffuser guide construction.

This type of diffuser guide construction, which is open at the top, distributes the contact pressure of the bulk material over several channels, so that the entire column of material does not stand on a sheet, e.g. the flank of the air distribution cone. This results in a more even flow and less material remains on the sheets.

It is also preferred that the diffuser guide construction is formed by a pipe which is arranged around the air supply pipe of the central injection device and is closed at the upper end. This prevents bulk material from reaching the air distribution cone and remaining there. The tube is preferably closed above the air supply. It is also preferred that the tube is closed in a tapered manner, for example in the form of a cone. This prevents the pipe closure from creating new areas where there is still remaining area. This variant can be retrofitted relatively easily in existing bulk material containers.

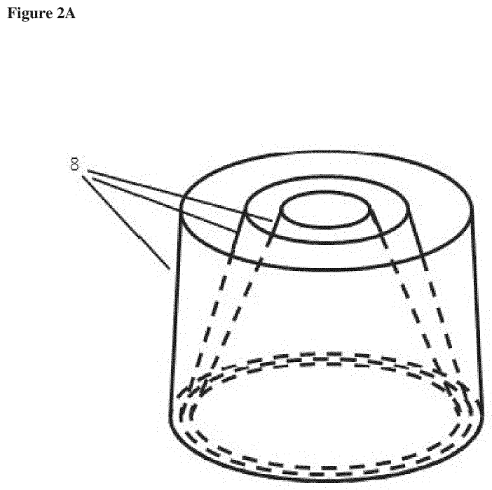

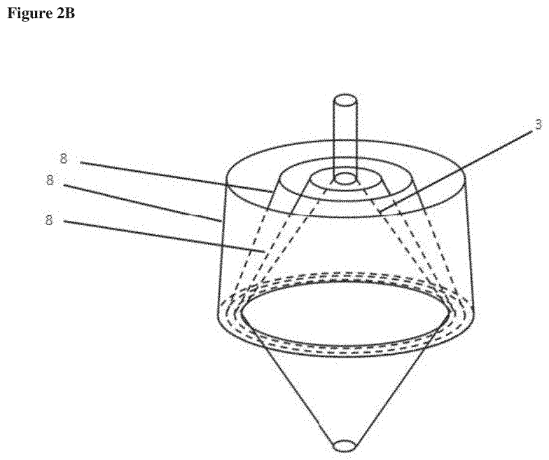

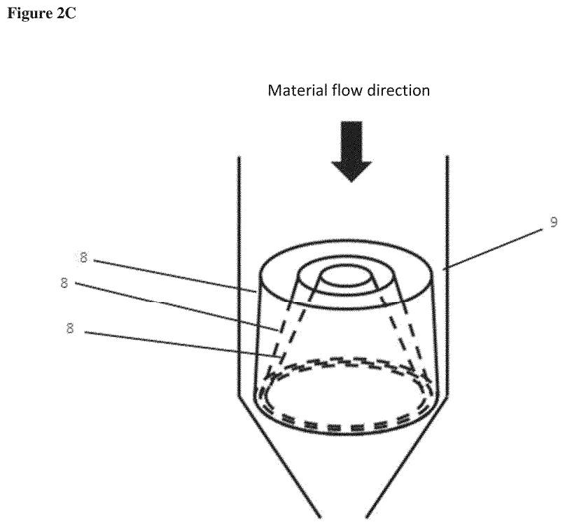

It is preferred that it is a central injection device which comprises an air supply pipe. The air distribution cone can either be a simple truncated cone or, as also shown in FIGS. 2B, 3 and 4, can be made approximately trapezoidal. The lower part of such an air distribution cone is usually formed by a perforated metal sheet. It is preferred that the diffuser guide construction encloses at least the upper part of the air distribution cone. The part that is possibly formed by the perforated plate does not have to be enclosed by the guide plate.

Another preferred possibility is that the guide plate, which is designed as a tube closed at the top, is formed by the air supply tube of the central injection device. This embodiment is particularly suitable for newly designed bulk material containers, but can also be retrofitted.

The bulk material container also includes a mostly funnel-shaped outlet through which the bulk material can be emptied. It is therefore particularly preferred that the bulk material container comprises a cylindrical and a conical part, wherein the inlet is in fluid communication with the cylindrical part and the outlet with the conical part. The diffuser guide construction is preferably arranged in the cylindrical part of the bulk material container. The flow channel is preferably located in the cylindrical part of the bulk material container.

Surprisingly, the diffuser guide construction according to the invention made it possible to even out the material flow in a bulk material container, preferably a dryer, preferably with a centrally positioned air injection device in such a way that the aforementioned dimensioning or quality and energy problems could be significantly improved.

The shape of the diffuser guide plates to be introduced can be rolled conically or made from individual trapezoidal segments (polygons). The sheets can be rolled as a whole or consist of several segments.

The bulk material container according to the invention is preferably a container with a cylindrical basic shape and a funnel-shaped outlet area. The cylindrical area from the upper level of the bulk material to the beginning of the funnel area is preferably referred to as sub-region A. The mostly funnel-shaped outlet area is referred to as sub-region B. The guide plates of the diffuser guide construction are preferably attached in the cylindrical area of the bulk material container. The guide plates in the container are arranged in a diffuser-like manner from the inside to the outside. It was surprising that this arrangement can improve the evening of the material flow in such a way. A more even flow of material has positive effects on the quality of the bulk material, as it prevents it from staying too long (drying) and from passing through the container too quickly. This has a positive effect on the material properties.

In the case of the invention, it is particularly important that one or several guide plates/diffuser(s) is/are introduced in a suitable manner in the flow channel of the bulk material, wherein the flow channel preferably represents the entire volume of sub-region A.

The angle, arrangement and height of the guide plates/diffuser(s) are primarily dependent on the container geometry, the shape of the bulk material, the material of the bulk material and the coefficient of friction. Depending on the material and application, variations here can further improve the result.

The optimal positioning can be determined by a corresponding simulation (for example finite elements) without the person skilled in the art becoming inventive. To position the guide plates, it has proven advantageous to attach spacers. These can be in the form of sheets or pipes, for example.

It has been shown here that it is particularly advantageous that at least one diffuser or guide plate is not designed parallel to the “remaining surface” (namely above the air distribution cone). A non-parallel design results in a particularly uniform flow of material. If a variant with several guide plates is selected, it is particularly preferred that the diffusers are arranged in such a way that the distance between the innermost diffuser and the remaining surface is greater at the top than at the bottom. The deviation from parallelism depends on the incline of the injection funnel. A diffuser sheet preferably exhibits a deviation of at least 3° from the imaginary parallel. The deviation is preferably a maximum of 90° from the imaginary parallel. 5° to 65° are particularly preferred.

Surprisingly, in the variant with the tapered open tubes, a certain improvement in the flow is achieved even with a guide plate. A plurality of guide plates or diffusers are preferably used, which then together form a diffuser guide construction. The diffuser guide construction can comprise several guide plates, preferably two or three, wherein the guide plates have openings of different sizes on the top and bottom and are arranged one inside the other.

For this embodiment, the more guide plates there are installed in a suitable manner, the more uniform the flow of material becomes. The maximum number of guide plates does not only depend on the size of the bulk material container or dryer, but also on the material thickness and the size of the bulk material, such as the granules that have to flow through the channels.

It has been shown that, also with regard to economic factors, three guide plates/diffusers are sufficient in most cases.

One or more guide plates can be installed either permanently (i.e. not easily dismantled) or dismantled again. The type of fastening plays a subordinate role here. All common connecting elements can be used (welding, riveting, gluing, pressing, plugging, etc.).

The bulk material is preferably granules, preferably plastic granules.

The invention proposes a technical construction for evening the emptying of a bulk material container with installations, in which the bulk material is branched by the proposed guide structure in such a way that a distinct evening of the bulk material flow is achieved above a centrally installed air distribution cone. The installations can be, for example, a centrally positioned air injection device.

If several guide plates are used, the guide plates can have the same or different slope angles on the base.

The guide plates can also be composed of at least three, preferably four, individual, substantially trapezoidal plates, which are joined together such that the shape approximates a truncated cone. This variant is primarily suitable for the upwardly tapering open pipes.

It is further preferred that the bulk material container comprises a central injection device with an air distribution cone, wherein the at least one guide plate of the diffuser guide construction is not parallel to the flanks of the air distribution cone. It is particularly preferred that all guide plates are not arranged parallel to the air distribution cone.

It is also preferred that the diffuser guide construction is arranged on the outside around the air distribution cone or at least a part thereof.

It is advantageous if the diffuser guide construction, especially the open diffuser guide construction, comprises additional spacers between the guide plates.

The diffuser guide construction can either be permanently installed or removable. A person skilled in the art is able to use the respective circumstances and designs to select which variant is more suitable for the respective case without becoming inventive.

It is particularly preferred that the bulk material container is a bulk material container for a dryer or a drying system.

In a further preferred embodiment, the invention relates to the use of a diffuser guide construction according to the invention in a bulk material container to even out the flow behavior of bulk material when the bulk material container is emptied.

The invention thus substantially comprises three particularly preferred embodiments, all of which have the same effect, namely preventing bulk material from accumulating in the bulk material container at certain points, especially the outer area of the air distribution cone, or from flowing at too slow a speed. In one of these preferred embodiments, the diffuser guide construction is designed in such a way that at least one guide plate in the form of an upwardly tapering tube is arranged around the air supply tube and at least part of the air distribution cone. In a further preferred embodiment, the tube is not tapered towards the top, but rather is a straight tube which is closed at the top. This construction prevents bulk material from ever reaching the outer surfaces of the air distribution cone. As an alternative to this, the air supply pipe can also be selected so wide that it has at least the width of the air distribution cone in diameter. In this case, the diffuser guide construction is formed by the air supply pipe itself and thus prevents bulk material from remaining on the flanks of the air distribution cone. All variants lead to the fact that a uniform speed of the bulk material is achieved and thus, in the case of a dryer, an even drying of the material can be achieved. This improves quality and at the same time improves the energy balance of the process.

In a further preferred embodiment, the invention relates to a method for loading and emptying a bulk material container, in which the bulk material is introduced into the bulk material container at the top and exits at a lower funnel-shaped outlet, wherein the bulk material is branched above the lower outlet via at least two channels, wherein these run from the middle of the bulk material container to the outside. The channels are advantageously formed by the guide plates.

It is preferred that a bulk material container according to the invention is used.

All of the described embodiments of the device can be used both for the claimed method and for the claimed use without this having to be explained in detail.

In a further preferred embodiment, the invention relates to a drying device comprising a bulk material container according to the invention. The drying performance is significantly improved compared to the prior art due to the increased and uniform quality of the bulk material.

Another advantage of the invention is that the open diffuser guide construction in the lower area of the bulk material container effects targeted guidance and thus quantification of individual bulk material flows to one another and achieves it by reducing the shear and/or transverse forces.

### EXAMPLES AND FIGURES

The invention is explained below with reference to figures, without being restricted thereto.

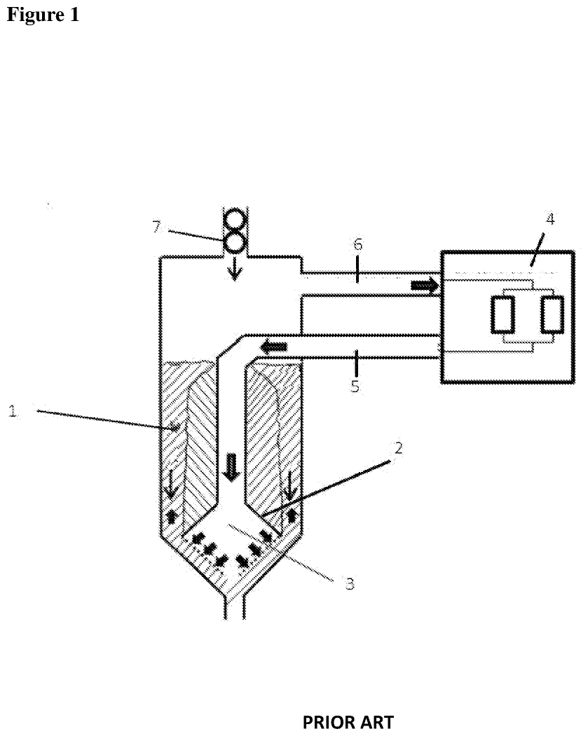

FIG. 1:

FIG. 1 shows an embodiment from the prior art. The disadvantages described can be seen in the form of the striped areas. On the one hand, material remains on the flanks 2 of the air distribution cone 3; on the other hand, the material passes through the container too quickly at the outer edges. Both of these have a detrimental effect on the quality of the bulk material.

FIG. 2:

FIG. 2 shows a preferred embodiment of the open diffuser guide construction with three guide plates 8

(A). In Fig. B, the air distribution cone 3 is also shown and in Fig. C, the bulk material container 9 is shown. It can be clearly seen that the diffuser guide structure is arranged in the cylindrical part of the bulk material container 9.

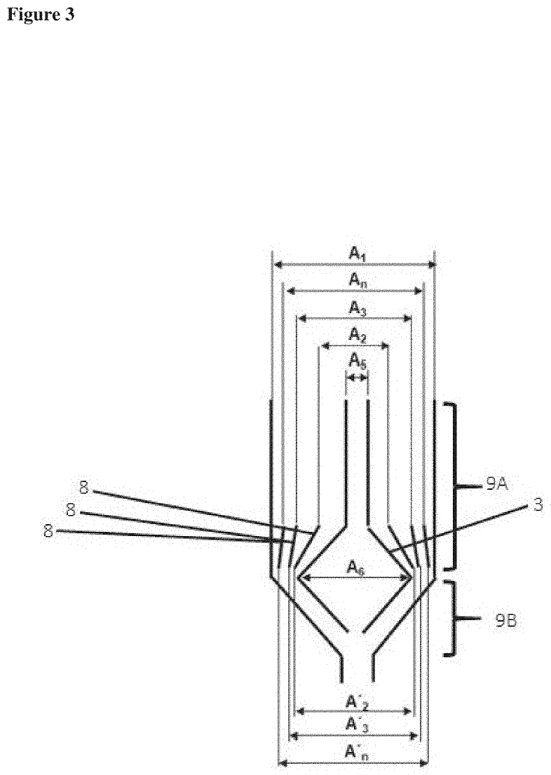

FIG. 3:

FIG. 3 shows a preferred embodiment of the invention with a plurality of guide plates 8 of an open diffuser guide construction. It is shown that the guide plates 8 are not arranged parallel to the flank 2 of the air distribution cone 3.

Here, A1 (container)>A2 and A2<A3.

Bulk infeed:

A₁=container, A₂=1. Diffuser, A₃=2. Diffuser, Aₙ=nth diffuser,

A₅=pipe leads to air distribution cone,

A₆=max distribution cone,

Bulk material outlet:

A′₂=diffuser 1, A′₃=diffuser 2, A′ₙ=n-th diffuser

Area of the tank, cylindrical part Aᵢ>Area of diffusers, inlet A₂ to Aₙ (A₁>A₂ to Aₙ)

Surface diffusers, inlet A₂ to Aₙ>supply air distribution cone (A₂ to Aₙ>A₅)

Inlet diffusers<outlet: (A₂<A′₂, A₃<A′₃, An<A′ₙ)

This aspect distinguishes the invention from the prior art, because, unlike in the prior art, the claimed shape of the guide plates is not funnel-shaped, but rather is designed in the shape of a truncated cone.

All outlet diffusers<container in the cylindrical part (A′₂ to A′ₙ<A₁)

All outlet diffusers>max distribution cone (A′₂ to A′ₙ>A₆

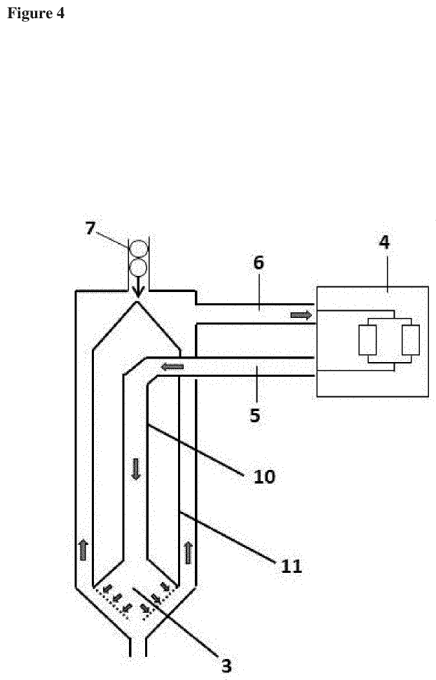

FIG. 4:

In FIG. 4, an embodiment is shown with a tube 11 closed at the top, which does not taper upwards. It can be seen here that the pipe closure is selected in such a way that no new remaining area for the bulk material 7 is created.

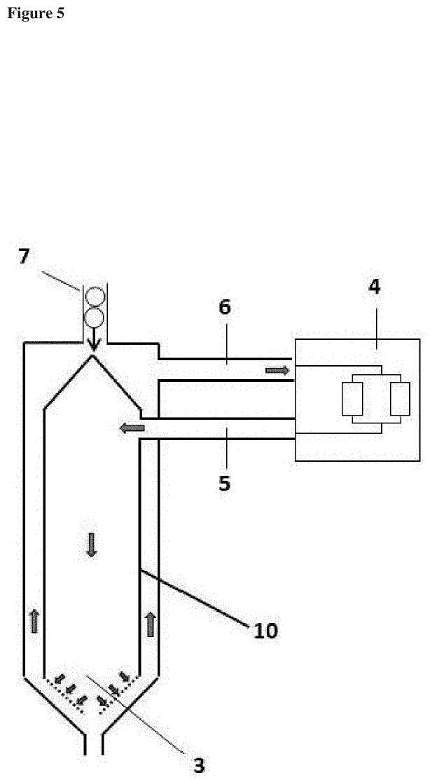

FIG. 5:

In FIG. 5, the variant is shown in which the guide plate of the diffuser guide construction is formed by the air supply pipe 10 of the central injection device. The air supply pipe 10 is thus the diffuser guide construction.

### LIST OF REFERENCE SYMBOLS

1 Preferential flow
2 Flank of the air distribution cone (remaining area)
3 Air distribution cone
4 Dehumidifier
5 Dry, warm supply air
6 Moist exhaust air
7 Bulk material
8 Guide plate of the diffuser guide construction
9 Bulk material container
9A Cylindrical part of the bulk material container
9B Conical part of the bulk container
10 Central injection device air supply pipe
11 Guide plate of the diffuser guide structure designed as a tube

1. Bulk material container, comprising
a centrally running injection device with an air distribution cone and a diffuser guide construction for pourable bulk material,
wherein the diffuser guide construction is arranged substantially centrally in the bulk material container and comprises at least one guide plate,
wherein the at least one guide plate is arranged at least partially around the air distribution cone and has a shape of a tube which tapers upwards resulting in at least one upwardly tapering tube or is closed at the upper end.

2. The bulk material container according to claim 1, wherein the diffuser guide construction comprises a plurality of guide plates, and
wherein the guide plates form upwardly tapering tubes and are arranged one inside the other.

3. The bulk material container according to claim 2, wherein the guide plates have the same or different angles of incline on a base.

4. The bulk material container according to claim 1, wherein the at least one upwardly tapering tube is composed of at least three individual, substantially trapezoidal sheets, which are joined together so as to approximate in shape a truncated cone.

5. The bulk material container according claim 1, wherein at least one guide plate of the diffuser guide construction is not designed parallel to flanks of the air distribution cone.

6. The bulk material container according to claim 1, wherein the air distribution cone has an outside and an inside and the diffuser guide construction connects to the outside of the air distribution cone.

7. The bulk material container according to claim 1, wherein the diffuser guide construction comprises spacers between the guide plates.

8. The bulk material container according to claim 1, wherein the diffuser guide construction is permanently installed.

9. The bulk material container according to claim 1, wherein the bulk container comprises a cylindrical and a conical part, and wherein an inlet is in fluid communication with the cylindrical part and an outlet is in fluid communication with the conical part, and wherein the diffuser guide construction is arranged in the cylindrical part.

10. The bulk material container according to claim 1, which is configured to be used for a dryer.

11. The bulk material container according to claim 1, wherein the at least one guide plate is formed by the plate of the central injection device and this is closed at its upper end.

12. Method for evening out flow behavior of bulk material, comprising:
providing a diffuser guide construction in a bulk material container,
wherein the diffuser guide construction evens out the flow behavior of the bulk material when emptying the bulk material container.

13. The method according to claim 12, wherein the diffuser guide construction effects in the lower region of the bulk material container a targeted guidance and thus a quantification of individual bulk material flows to one another by reducing the shear and/or transverse forces.

14. The method according to claim 12, wherein the diffuser guide construction is arranged substantially centrally in the bulk material container and comprises at least one guide plate, wherein the guide plate is arranged at least partially around an air distribution cone and has the shape of a tube that is tapered at the top or closed at the top.

15. Method for loading and emptying a bulk material container, comprising
introducing the bulk material into the bulk material container at the top and wherein the bulk material exits at a lower funnel-shaped outlet, and wherein the bulk material is branched above the lower outlet via at least two channels, which run from the middle of the bulk material container to an outside.

16. The bulk material container according to claim 1,
wherein the guide plate is closed at the upper end by a conical closure.

17. The bulk material container according to claim 2,
wherein the diffuser guide construction comprises two or three guide plates.

18. The bulk material container according to claim 1, wherein the diffuser guide construction is configured to be dismantled.

19. The bulk material container according to claim 11, wherein the central injection device is closed at its upper end by a conical closure.
